(19) United States
(12) Patent Application Publication
(10) Pub. No.: US 2025/0384289 A1
(43) Pub. Date: Dec. 18, 2025

(54) GENERATING CLASS-BALANCED SYNTHETIC DATA WITH FIDELITY-GUIDED RETRAINING

(71) Applicant: The Toronto-Dominion Bank, Toronto (CA)

(72) Inventors: Jesse Cole Cresswell, Toronto (CA); Maksims Volkovs, Toronto (CA); Taewoo Kim, Toronto (CA)

(73) Assignee: The Toronto-Dominion Bank, Toronto (CA)

(21) Appl. No.: 19/239,860

(22) Filed: Jun. 16, 2025

Related U.S. Application Data
(60) Provisional application No. 63/659,882, filed on Jun. 14, 2024.

(51) Int. Cl. G06N 3/09; G06N 3/0475

(52) U.S. Cl. CPC G06N 3/09; G06N 3/0475

(57) ABSTRACT

An example operation may include at least one of producing, by a class-conditioned sample generator executing on at least one processor communicatively coupled to a memory on a host platform, a synthetic feature set based on a label sequence and class information derived from received data, transmitting, by the host platform, a finalized synthetic sample to a computing device when the synthetic feature set satisfies a fidelity threshold, generating, by the computing device, a fidelity score based on a comparison of the finalized synthetic sample to the label sequence and the class information, retraining, by the computing device, the class-conditioned sample generator based on the fidelity score, and validating, by the computing device, the class-conditioned sample generator by transmitting a test prompt to the host platform, receiving a synthetic response generated by the class-conditioned sample generator, and comparing the synthetic response to previously stored synthetic data to validate the class-conditioned sample generator.

### CROSS-REFERENCE TO RELATED APPLICATIONS

This application claims priority to U.S. Provisional Patent Application No. 63/659,882, filed on Jun. 14, 2024, the entire disclosure of which is incorporated by reference herein.

This application is related via subject-matter to U.S. patent application Ser. No. 18/934,282, filed on Nov. 1, 2024, and U.S. patent application Ser. No. ______ Docket No. 24205-DAI-US-PAT2, entitled “CLASS-CONDITIONED SYNTHETIC TABULAR DATA GENERATION,” filed on Jun. 16, 2025, the entire disclosures of which are incorporated by reference herein.

### BACKGROUND

Synthetic data generation plays a role in augmenting training corpora for machine learning models, particularly in domains involving structured, tabular datasets with class balance and statistical fidelity. Traditional generative approaches often struggle to preserve class-conditional feature distributions or scale effectively across diverse class labels; accordingly, there is a demand for systems that can generate high-fidelity, label-consistent synthetic data using scalable, structure-aware modeling techniques.

### SUMMARY

One example embodiment provides an apparatus that includes a computing device, and a host platform comprising a memory and at least one processor communicatively coupled to the memory, the at least one processor may perform at least one of produce, using a class-conditioned sample generator, a synthetic feature set based on a label sequence and class information based on received data, and transmit, when the synthetic feature set satisfies a fidelity threshold, a finalized synthetic sample to the computing device, wherein the computing device is configured to generate a fidelity score based on a comparison of the finalized synthetic sample to the label sequence and the class information, use the fidelity score to retrain the class-conditioned sample generator, and validate the class-conditioned sample generator by transmitting a test prompt to the host platform, receiving a synthetic response generated by the class-conditioned sample generator, and comparing the synthetic response to previously stored synthetic data to validate the class-conditioned sample generator.

Another example embodiment provides a method that includes at least one of producing, by a class-conditioned sample generator executing on at least one processor communicatively coupled to a memory on a host platform, a synthetic feature set based on a label sequence and class information derived from received data, transmitting, by the host platform, a finalized synthetic sample to a computing device when the synthetic feature set satisfies a fidelity threshold, generating, by the computing device, a fidelity score based on a comparison of the finalized synthetic sample to the label sequence and the class information, retraining, by the computing device, the class-conditioned sample generator based on the fidelity score, and validating, by the computing device, the class-conditioned sample generator by transmitting a test prompt to the host platform, receiving a synthetic response generated by the class-conditioned sample generator, and comparing the synthetic response to previously stored synthetic data to validate the class-conditioned sample generator.

A further example embodiment provides a computer readable storage medium comprising instructions, that when read by a processor, cause the processor to perform at least one of producing, by a class-conditioned sample generator executing on at least one processor communicatively coupled to a memory on a host platform, a synthetic feature set based on a label sequence and class information derived from received data, transmitting, by the host platform, a finalized synthetic sample to a computing device when the synthetic feature set satisfies a fidelity threshold, generating, by the computing device, a fidelity score based on a comparison of the finalized synthetic sample to the label sequence and the class information, retraining, by the computing device, the class-conditioned sample generator based on the fidelity score, and validating, by the computing device, the class-conditioned sample generator by transmitting a test prompt to the host platform, receiving a synthetic response generated by the class-conditioned sample generator, and comparing the synthetic response to previously stored synthetic data to validate the class-conditioned sample generator.

### BRIEF DESCRIPTION OF DRAWINGS

FIG. 1 is a system diagram illustrating an operating environment of a software service, according to examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a chatbot service that utilizes an AI model, according to examples and features of the instant solution.

FIG. 3A is a system diagram illustrating an operating environment for generating class-balanced synthetic data with fidelity-guided retraining, according to examples and features of the instant solution.

FIG. 3B is a flow diagram illustrating the generation of class-balanced synthetic data with fidelity-guided retraining, according to examples and features of the instant solution.

FIG. 3C is another flow diagram illustrating the generation of class-balanced synthetic data with fidelity-guided retraining, according to examples and features of the instant solution.

FIG. 3D is a flow diagram of a chatbot request being processed by the host platform, according to examples and features of the instant solution.

FIG. 3E is another flow diagram of a chatbot request being processed by the host platform, according to examples and features of the instant solution.

FIG. 4A is a flow diagram illustrating a method for generating class-balanced synthetic data with fidelity-guided retraining service, according to examples and features of the instant solution.

FIG. 4B is another flow diagram illustrating a method for generating class-balanced synthetic data with fidelity-guided retraining service, according to examples and features of the instant solution.

FIG. 5 is a system diagram illustrating a computing environment according to the instant solution's example features, structures, or characteristics.

### DETAILED DESCRIPTION

This instant solution relates to systems and methods for synthetic data generation, fidelity evaluation, and adaptive retraining architectures tailored for class-conditioned artificial intelligence (AI) models. More specifically, the instant solution addresses the technical challenges of emulating evolving data distributions using generative models, ensuring statistical fidelity, and dynamically updating models based on divergence metrics detected during synthetic simulation or live inference.

Modern AI deployments, especially in regulated or data-scarce domains, often face limitations in acquiring representative and sufficiently diverse real-world data. This can result in degraded model performance, bias propagation, or failure to generalize to production contexts. To overcome these limitations, synthetic data generation has emerged as a technique for augmenting training datasets. However, conventional synthetic data generators often lack class-awareness, produce unrealistic artifacts, or do not support recursive simulation dynamics to mimic real-world progression of data characteristics over time.

The present instant solution provides a novel architecture and method that integrates class-specific ensemble modeling, structured noise injection, recursive feature integration, and fidelity-triggered retraining. The system generates synthetic tabular datasets conditioned on classification labels, with support for multi-stage transitions governed by dynamic vector fields. By leveraging a recursive integration loop, the system emulates data transformations over semantic or temporal phases. A fidelity monitoring subsystem evaluates statistical consistency using divergence metrics such as Wasserstein distance and Kullback-Leibler (KL) divergence, triggering retraining cycles for affected classes via a per-class update mechanism.

The instant solution introduces a modular and scalable architecture that enables the generation of synthetic data with fine-grained fidelity control, supports hardware-agnostic compute execution, and allows dynamic model governance through structured feedback loops. The instant solution can be deployed in cloud, edge, or hybrid environments and is suitable for use in testing, forecasting, AI pre-deployment validation, and continuous learning systems.

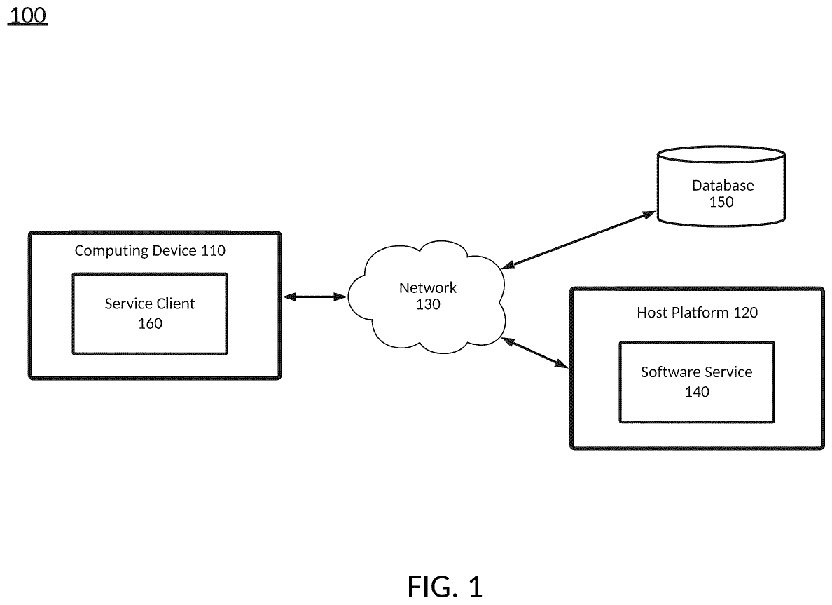

FIG. 1 is a system diagram 100 illustrating an example operating environment of the instant solution. As shown, at least one computing device 110, and a host platform 120 communicate via a network 130. The host platform 120 may host a software service 140. The software service 140 may communicate with at least one database 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include at least one interconnected computer network. For example, network 130 may be or may include an Ethernet network, an asynchronous transfer mode (ATM) network, a wireless network, a telecommunications network or the like.

The software service 140 provides the service logic. It may provide at least one Application Programming Interface (API) for communicating with at least one service client 160. A “thick” user interface client that runs on a computing device 110 may utilize the APIs to communicate with the software service 140. Further, the software service 140 may provide hosted User Interfaces (UIs) that can be accessed through browser-based software on some computing devices 110.

The at least one service client 160 can enable service access for end users and may come in a variety of forms including, but not limited to, a mobile device application (“app”) or a web portal accessed via a browser on a computing device 110 such as a laptop or desktop computer.

Detailed descriptions of the architecture and operation of the synthetic data generation and retraining logic in the instant solution are further described and depicted herein.

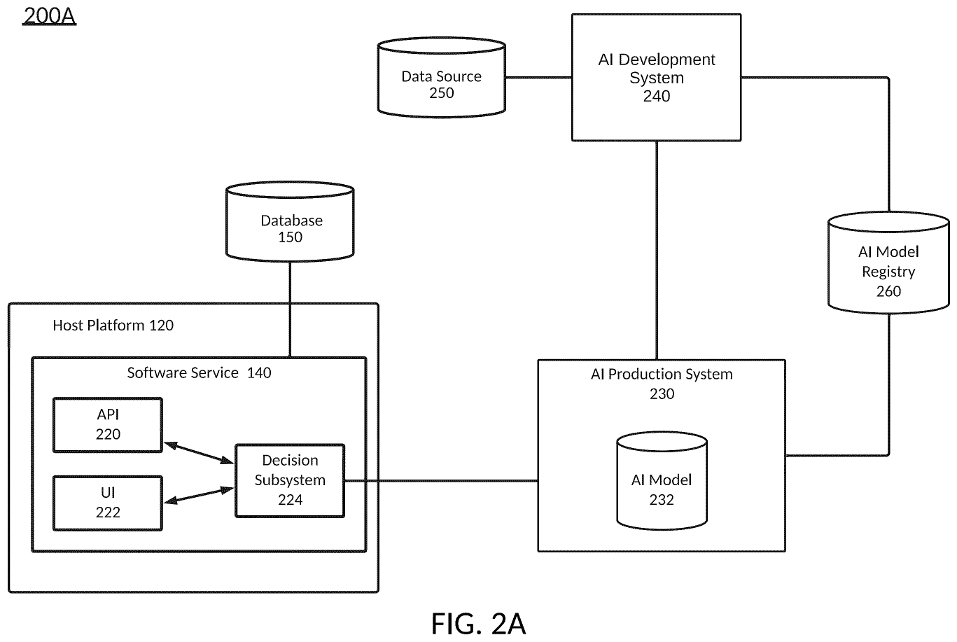

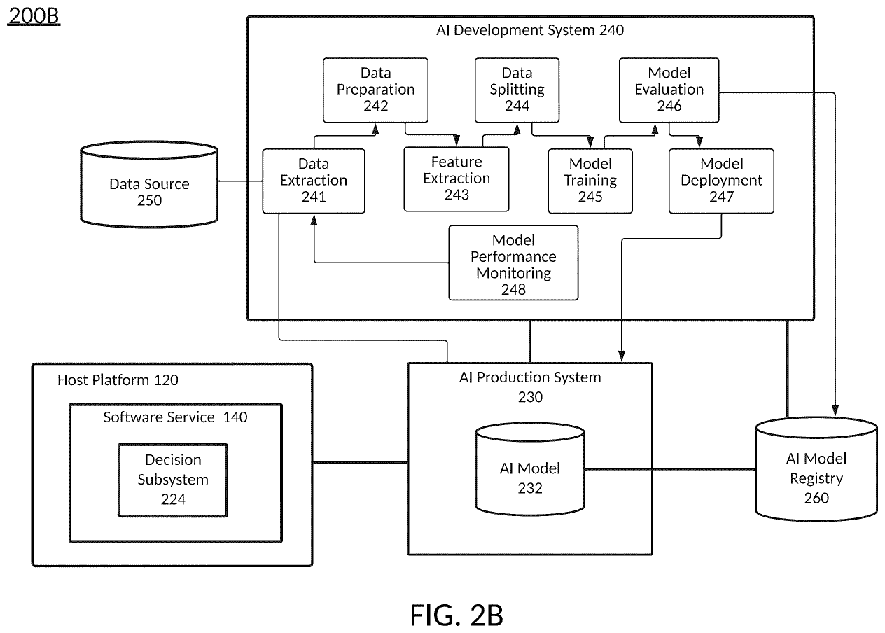

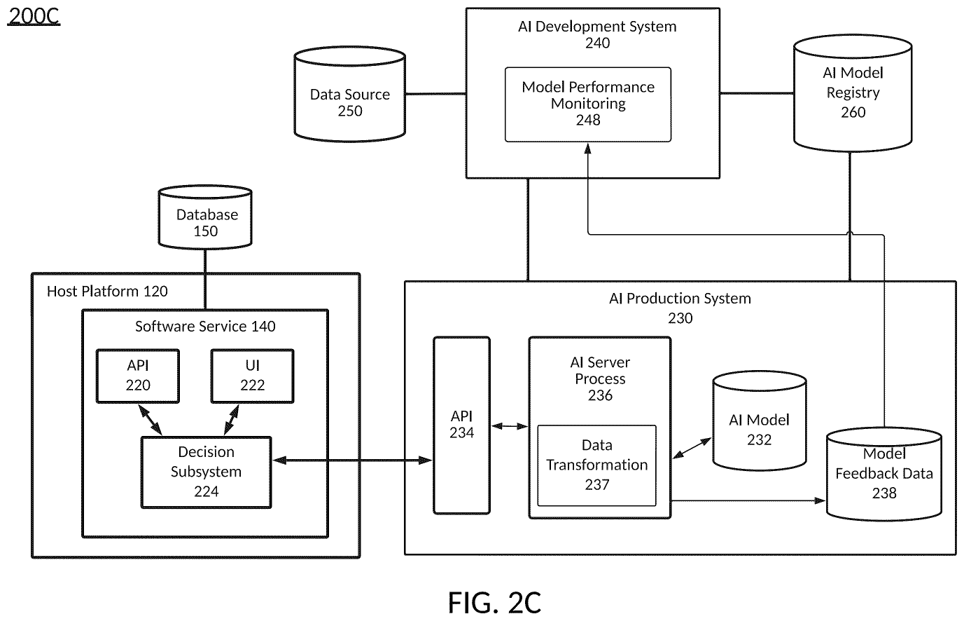

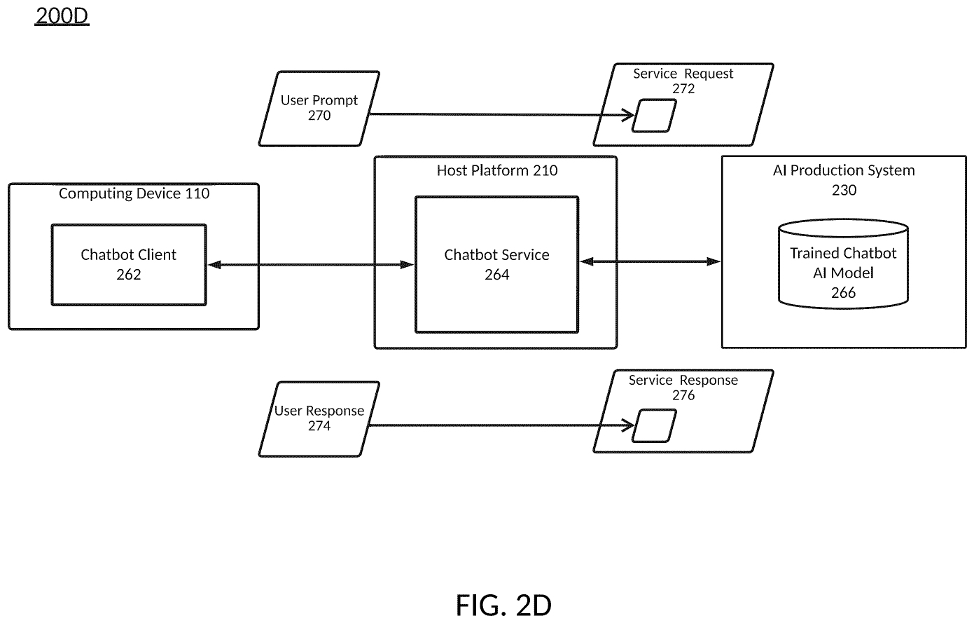

FIG. 2A illustrates an artificial intelligence (AI) network diagram 200A that supports AI-assisted decision points in a software service 140 executing on a host platform 120. While the example instant solution shown utilizes a neural network, which is a type of machine learning model, other branches of AI, such as computer vision, fuzzy logic, expert systems, deep learning, generative AI, and natural language processing, may be employed in developing the AI model 232 in this instant solution. Further, the AI model 232 included in these examples and features of the instant solution is not limited to particular AI algorithms. Any algorithm or combination of algorithms related to supervised, unsupervised, and reinforcement learning may be employed.

The AI models, machine learning models, neural networks, and other branches of AI described and depicted herein build upon the fundamentals of predecessor technologies and form the foundation for future advancements in artificial intelligence. An AI classification system describes the stages of AI progression, beginning with reactive machines, followed by present-day AI models categorized as limited memory machines or artificial narrow intelligence. These stages progress toward theory of mind (artificial general intelligence) and ultimately self-aware models (artificial superintelligence). Limited memory machines form the basis of many current AI models that can learn from large volumes of data, detect patterns, solve problems, generate outputs, and predict results, while retaining the capabilities of reactive machines.

Examples of AI models classified as limited memory machines include chatbots, virtual assistants, machine learning engines, neural networks, deep learning architectures, natural language processing systems, generative AI models, and future AI technologies that possess the same characteristics. These models rely on accumulated experience and memory structures to enhance performance over time.

For example, a neural network is a type of machine learning model that uses training data to build associations and increase accuracy across classification, clustering, or analysis tasks. Neural networks are foundational to deep learning models and provide the core mechanisms for inference in many modern applications. These models also enable other forms of AI to perform high-speed operations and accurate decision-making.

For example, generative AI models integrate limited memory machine techniques, including machine learning and deep learning, and serve as foundational tools for future AI models. In the context of theory of mind classification, generative AI models are expected to perceive and respond to interactions by producing appropriate, contextual reactions. These capabilities further evolve in self-aware models, where AI may possess simulated emotional awareness and the ability to form internalized beliefs and needs.

AI models used in the instant solution may include at least one of the following: a machine learning model, a neural network model, a deep learning model, a generative AI model, or any combination thereof. The AI model 232 is central to the inference capabilities of the instant solution and may refer to both present-day AI models and future variants derived from evolving AI branches.

The software service 140, executing on the host platform 120, may expose at least one API 220 that enables structured communication with other services or applications. The API 220 may utilize messaging and interaction protocols such as Simple Object Access Protocol (SOAP), Remote Procedure Calls (RPC), or Representational State Transfer (REST). In the instant solution, the API 220 may transmit data to a decision subsystem 224 within the software service 140, enabling automated decisions based on input payloads. Information received through the API 220 or generated during processing may be stored in a database 150.

The software service 140 may also provide a user interface (UI) 222 for interacting with end users. The UI 222 may include a server-side hosted graphical user interface rendered via template-based or component-based frameworks. The UI 222 may send data to the decision subsystem 224 as part of the operational flow, and UI interactions may be persisted in the database 150 for auditing or future processing.

The decision subsystem 224 performs logic that drives the behavior of the software service 140. It may receive inputs from both the API 220 and the UI 222 and may use current configuration or historical service data retrieved from the database 150. The decision subsystem 224 may provide computed outputs back to the API 220 or UI 222, completing the interaction flow with a decision result.

The instant solution includes functionality that preserves class balance in synthetic data generation. The software service 140 includes a label frequency profiler configured to determine label frequencies across the received data, including prompt data, response data, and test data. A label sequencing sampler constructs a label sequence based on the label frequency distribution, and a class-conditioned sample generator produces synthetic feature sets using both the label sequence and associated class information. These synthetic outputs are used as candidate responses or examples generated by the AI model 232.

To ensure quality, a fidelity check module is configured to compare the synthetic feature set with characteristics of the received data. The fidelity check module computes a fidelity score and determines whether the synthetic data meets a threshold for acceptance. When the fidelity threshold is satisfied, the response is returned to the computing device via the service client. When the fidelity threshold is not met, a retraining signal is constructed containing the label and divergence data.

The decision subsystem 224 may invoke the AI production system 230 to support or complete a decision. The AI production system 230 includes the AI model 232 that is executed to return a decision-support result, such as a prediction, classification, recommendation, or interface element. The AI production system 230 may be hosted in a server, deployed in a cloud environment, or distributed across multiple nodes to scale inference tasks.

The AI model 232 used by the AI production system 230 may originate from an AI development system 240. The AI development system 240 is responsible for training and generating the AI model 232 using input from one or more data sources 250. These sources may be local, remote, third-party, or internal systems, and may contain real-world or synthetic data. In addition, the AI development system 240 may incorporate feedback data from the AI production system 230 to refine or retrain existing models, including processing retraining signals generated in response to fidelity check failures.

The AI development system 240 may operate on dedicated servers, in a cloud-hosted infrastructure, or across distributed nodes. It may include support for analytics engines and data pipelines that support scalable model training, validation, and version control. Once trained and validated, the AI model 232 is stored in an AI model registry 260.

The AI model registry 260 may be accessed by either the AI development system 240 or the AI production system 230. The registry 260 may be implemented as a dedicated storage component, a cloud-based object store, or a distributed database. The AI model registry 260 may maintain multiple versions of the AI model 232, enabling smooth rollout, rollback, and version tracking across development and production environments.

FIG. 2B illustrates a process 200B for developing and maintaining at least one AI model 232 that supports AI-assisted decision-making within a software service 140. The AI model 232 is trained, validated, deployed, and monitored through the collaboration of multiple system components, including an AI development system 240, an AI production system 230, a data source 250, a model registry 260, and a host platform 120.

The AI development system 240 initiates model creation by performing data extraction 241. In this step, raw data is retrieved from at least one data source 250. The data source 250 may be internal to the organization, external through third-party APIs, or sourced from cloud-hosted data lakes. In addition, the AI development system 240 may retrieve production feedback data from the AI production system 230. This feedback loop enables the development system to continuously update its training inputs using inference outcomes from real-world use cases.

Once the raw data is extracted, the AI development system 240 processes the dataset during data preparation 242. This step includes statistical analysis to understand data quality, distribution patterns, and structural consistency. The system may apply data normalization techniques, such as scaling or encoding, and may eliminate noise such as null values, out-of-range values, or text entries that exceed acceptable length. The data preparation 242 process ensures that useful, clean input reaches the model training stage.

Following preparation, feature extraction 243 identifies which aspects of the data contribute to the model's predictive power. Features may be direct fields in the prepared data or derived fields that are to be joined with other datasets. In some configurations, feature extraction 243 includes enrichment steps, where values from the original dataset are cross-referenced with auxiliary data in the data source 250. This ensures the resulting training data reflects a higher-order understanding of the domain.

After features have been extracted, the resulting dataset is split during data splitting 244. This creates two partitions: a training dataset and a validation dataset. The training dataset is used to build the AI model 232, while the validation dataset is used to measure generalization accuracy and detect overfitting. This step is performed to achieve real-world reliability of the deployed AI model.

Model training 245 begins with the training dataset. The AI development system 240 selects a machine learning or deep learning algorithm, which may include decision trees, gradient boosting machines, convolutional neural networks, or transformer-based architectures. An initial set of algorithm parameters is assigned, and training begins. The model is iteratively refined by adjusting the parameters based on feedback from performance scores obtained using the validation dataset.

Once an initial model has been trained, model evaluation 246 is conducted to simulate how the AI model 232 will behave under production conditions. This step is performed in a staging environment, which mirrors the infrastructure and configuration of the AI production system 230. The staging environment tests the model on validation data, stress tests, edge cases, and operational limits. Model evaluation 246 may use the same validation dataset from data splitting 244 or incorporate a separate, previously unseen dataset to ensure robustness.

After passing evaluation, the model is stored in an AI model registry 260. The registry serves as a version-controlled repository for model binaries, metadata, evaluation scores, lineage data, and deployment status. The AI model registry 260 may be implemented as a cloud-based model storage solution or as a distributed database system. Models stored in the registry may be queried or retrieved by both the AI development system 240 and the AI production system 230.

When the AI model 232 is ready for inference, it is deployed to the AI production system 230 during model deployment 247. The production system receives the deployed model and prepares it for execution using containerization or native runtime support. The production system is responsible for low-latency serving of predictions in response to input events, including those originating from the decision subsystem 224 of the software service 140.

Once the AI model 232 is active, the AI development system 240 performs ongoing model performance monitoring 248. This monitoring includes collecting inputs and outputs, computing model accuracy metrics in real-time, and comparing prediction outcomes against expected behavior. Model performance monitoring 248 also includes evaluating drift, changes in data patterns that can affect model quality. The AI development system 240 may use this information to schedule model retraining or to raise alerts for manual review.

As performance metrics accumulate, they are passed back to the AI development system 240 to determine whether retraining is to be triggered. The retraining process involves re-executing the steps from data extraction 241 through to model deployment 247, incorporating new data and feedback metrics. This closed-loop learning cycle allows the AI system to remain responsive to dynamic environments and changing data distributions.

The AI development system 240 may include a user interface for configuring and orchestrating the development process. Through this interface, engineers and data scientists can monitor each stage of the pipeline, inspect data flows between steps, adjust feature selection strategies, override default algorithm parameters, and approve deployment candidates. The interface may also visualize model performance over time and support manual intervention when thresholds are breached.

The AI development system 240 may support distributed execution. For example, data preparation 242, feature extraction 243, and model training 245 may run across parallel computing nodes to accelerate processing of large datasets. The development system may also use distributed queues or batch processing frameworks to manage workload and maintain lineage for traceability.

The AI production system 230 may be deployed on edge devices, cloud virtual machines, or hybrid infrastructures. The AI model 232 can be served through RESTful APIs or embedded into software containers for co-location with real-time systems. Production deployment may include version tagging, rollback capabilities, and zero-downtime model switching.

The software service 140, hosted on the host platform 120, communicates with the AI production system 230 during live inference workflows. The decision subsystem 224 of the software service 140 may request predictions or classifications, and the AI model 232 returns results that influence business logic, user interface prompts, or backend processing.

Data source 250 may include transactional logs, telemetry streams, system event feeds, or curated training datasets. Data may be ingested via batch loading, streaming pipelines, or direct API queries. The data source 250 may also support schema evolution, allowing new types of information to be integrated into the model lifecycle without requiring infrastructure redesign.

In some configurations, the AI development system 240 and AI production system 230 exchange metadata and diagnostics in real time. For example, after the prediction is served, the production system may log feature values, prediction confidence scores, and latency metrics, which are streamed back to the development system. This fine-grained monitoring ensures operational transparency and supports long-term reliability.

FIG. 2C illustrates a process 200C for utilizing an AI model 232 to support AI-assisted decision points in a software service 140. Although the AI model 232 shown reflects machine learning functionality, the instant solution is not limited to machine learning algorithms and is applicable to any artificial intelligence method or combination of methods, including those not yet developed.

The AI production system 230 is used by a decision subsystem 224 within the software service 140 to assist in determining responses or recommendations during live service execution. The AI production system 230 exposes an API 234, which allows incoming requests to be submitted for model execution. The API 234 is handled by an AI server process 236. A request submitted through the API 234 may include an identifier for a specific AI model 232 and a data payload. The data payload may include values obtained from the API 220 or the user interface 222 of the software service 140, or from other software modules hosted in the host platform 120.

Once the request is received by the AI server process 236, the request data is routed through a data transformation module 237. The purpose of the data transformation 237 is to ensure that the input data aligns with the feature expectations of the AI model 232. Transformation operations may include value normalization, missing value imputation, field recombination, or enrichment using auxiliary data pulled from one or more external data sources 250.

After the input data has been successfully transformed, the AI server process 236 executes the selected AI model 232 using the prepared data. Once the model produces a result, the result is returned to the original caller of the API 234, which in this case is the decision subsystem 224 of the software service 140. The result may be a classification, prediction, numerical value, or instruction, depending on how the AI model 232 is structured and what the decision subsystem 224 expects.

In some examples, the returned result may directly influence a live interaction on the user interface 222. For example, when the software service 140 is implemented as a chatbot interface, the prediction result may be rendered as a conversational reply. In other cases, the result may serve as a decision variable in downstream application logic.

In one configuration, the response from the AI model 232 includes a unique request identifier. This identifier enables the software service 140 to associate follow-up actions, such as feedback, with the original request. The identifier may be preserved by the decision subsystem 224 for the purpose of submitting post-execution assessments of AI performance.

Following execution, the AI server process 236 may create a model feedback record that documents the output, any known ground truth, and any evaluation metrics provided. This record is stored in a model feedback data store 238. These records serve as an audit trail and can be used to measure model drift, validate prediction quality, and identify performance degradation.

The API 234 includes an interface to accept post-execution feedback on any previously served model response. The feedback interface enables external components, such as the decision subsystem 224, to send ratings or results back to the AI production system 230 after an execution has completed. Feedback records submitted through the API 234 may include a reference to the original request identifier, as well as details on whether the AI model 232 performed accurately, suboptimally, or incorrectly.

Upon receiving feedback through the feedback interface, the AI server process 236 appends a new entry to the model feedback data 238. The model feedback data 238 acts as a historical repository of runtime observations and is accessible to downstream systems, including the AI development system 240.

The AI development system 240 includes a model performance monitoring component 248. The model feedback data 238 is made available to the model performance monitoring 248 module, either through scheduled queries or through a real-time streaming interface. This feedback loop enables the AI development system 240 to track model accuracy over time and to detect when performance drops below acceptable thresholds.

When performance degradation is detected, model retraining is initiated. Retraining involves repeating steps 241 through 246 (see FIG. 2B) using a combination of updated data from the data source 250 and the model feedback data 238. This approach ensures that new behavioral patterns, error types, or emerging conditions are integrated into future versions of the AI model 232.

Retraining may be triggered periodically as part of a business-driven cadence or dynamically based on thresholds computed by the model performance monitoring 248 component. For example, when the recent accuracy rate for a specific prediction type falls below a defined percentage, retraining may be automatically queued. Similarly, when a significant amount of disagreement between model outputs and user feedback is detected, the retraining loop may be engaged.

The AI production system 230 may include a user interface for operational monitoring. This interface provides the ability to visualize live model throughput, latency, success/failure ratios, and request volume. The interface may also include controls to inspect model feedback data 238, confirm retraining thresholds, and approve or pause deployment of updated models. Although not shown in FIG. 2C, the interface may integrate tightly with DevOps and MLOps tools used in enterprise environments.

This architecture, as illustrated in FIG. 2C, supports closed-loop learning and enables production-level models to adapt based on real-world conditions. The collaboration between the AI production system 230 and the AI development system 240, coupled with persistent feedback collection, ensures that the AI model 232 remains current, accountable, and aligned with system goals.

The components shown in FIG. 2C collectively support the operation of the instant solution. The software service 140, which includes the decision subsystem 224, acts as the main interaction point for executing AI models in real-time. The decision subsystem 224 sends inference requests to the AI production system 230, receives responses that affect application logic or user interface rendering, and optionally provides feedback into model feedback data 238. This enables the instant solution to operate as an AI-assisted decision engine that continuously learns from runtime behavior. The collaboration between the host platform 120, the AI production system 230, and the AI development system 240 ensures that the AI model 232 evolves over time based on monitored outcomes and user-provided feedback, fulfilling the goals of an adaptive system architecture.

FIG. 2D is a system diagram illustrating a chatbot service that utilizes a trained chatbot AI model 266 in conjunction with a computing device 110, host platform 210, and AI production system 230. The instant solution provides a complete lifecycle interaction from user prompt ingestion to inference response delivery, driven by model-based reasoning.

The computing device 110 hosts a chatbot client 262 that initiates interaction with the chatbot service 264. The chatbot client 262 may operate as a native app, browser interface, or embedded widget, and captures user input in the form of a user prompt 270. The chatbot client 262 is an example of the service client 160 described in FIG. 1, configured to interact with the software service 140.

Upon receiving the user prompt 270, the chatbot client 262 transmits it to the chatbot service 264, which runs on the host platform 210. The chatbot service 264 is an instance of the software service 140 described in FIG. 2A and includes architectural components such as an API 220, a UI 222, and at least one decision subsystem 224. The chatbot service 264 prepares a service request 272 that includes the user prompt 270 and may further specify a model identifier pointing to the trained chatbot AI model 266.

The service request 272 is transmitted to the AI production system 230 for processing. The AI production system 230, shown in FIGS. 2A through 2D, includes the trained chatbot AI model 266, which is a specialized instance of the AI model 232. The AI production system 230 receives the request and parses the model identifier and user prompt 270.

In some examples of the instant solution, the AI production system 230 applies preprocessing to the user prompt 270 using Natural Language Processing (NLP) or Natural Language Understanding (NLU) techniques. This may include entity extraction, tokenization, or intent classification. These operations ensure that the prompt is transformed into an internal representation suitable for inference by the trained chatbot AI model 266.

The transformed prompt is then routed to the trained chatbot AI model 266, which processes the request using natural language generation (NLG) techniques, neural networks, or other AI reasoning mechanisms. The trained chatbot AI model 266 generates a user response 274 that represents a conversational, action-oriented, or content-specific reply to the original user prompt 270.

Once the user response 274 is created, the AI production system 230 wraps the output into a service response 276 and returns it to the chatbot service 264. The service response 276 includes the model-generated output along with any metadata to preserve request context.

Upon receiving the service response 276, the chatbot service 264 extracts the user response 274 and routes it back to the chatbot client 262 for display or user engagement. The chatbot client 262 then emits the user response 274 through a graphical interface or voice assistant, completing the round-trip interaction initiated by the user prompt 270.

The architecture shown in FIG. 2D exemplifies the operational behavior of the instant solution, where a client-facing service (chatbot service 264) acts as an intermediary between a user and a trained AI model. The solution enables real-time, intelligent decision-making, powered by a retrainable and model-governed backend hosted within the AI production system 230. Integration of preprocessing (e.g., NLP), model execution (e.g., NLG), and structured response delivery through service responses ensures that the instant solution provides responsive, accurate, and adaptable conversational support.

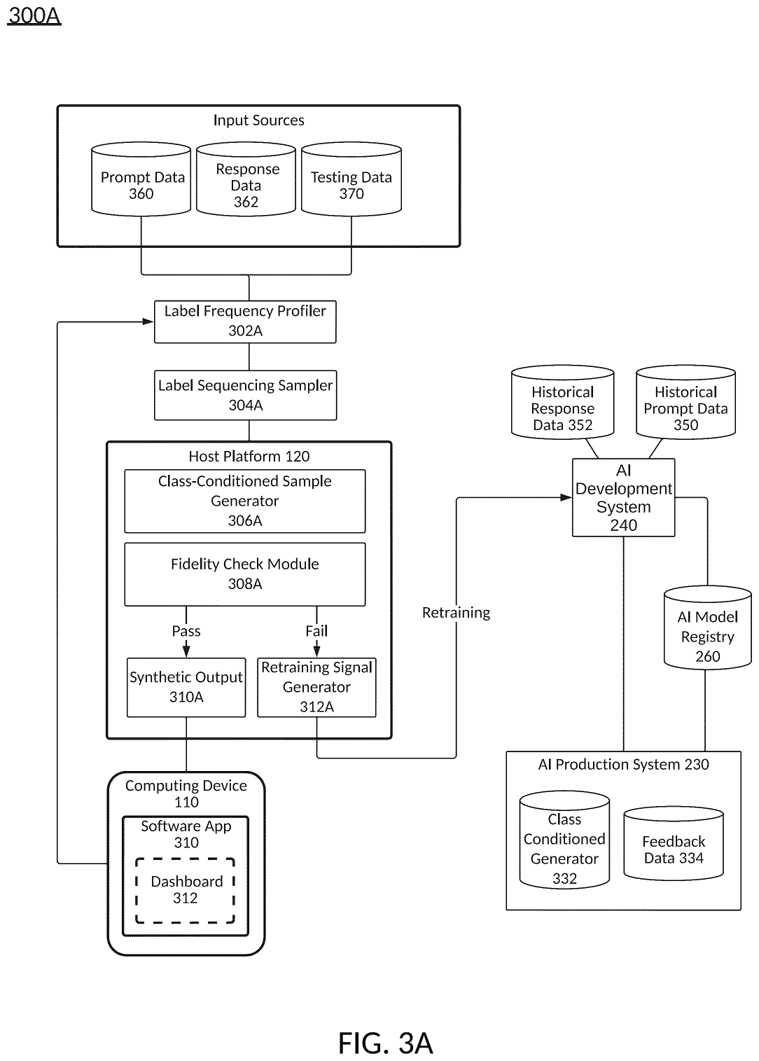

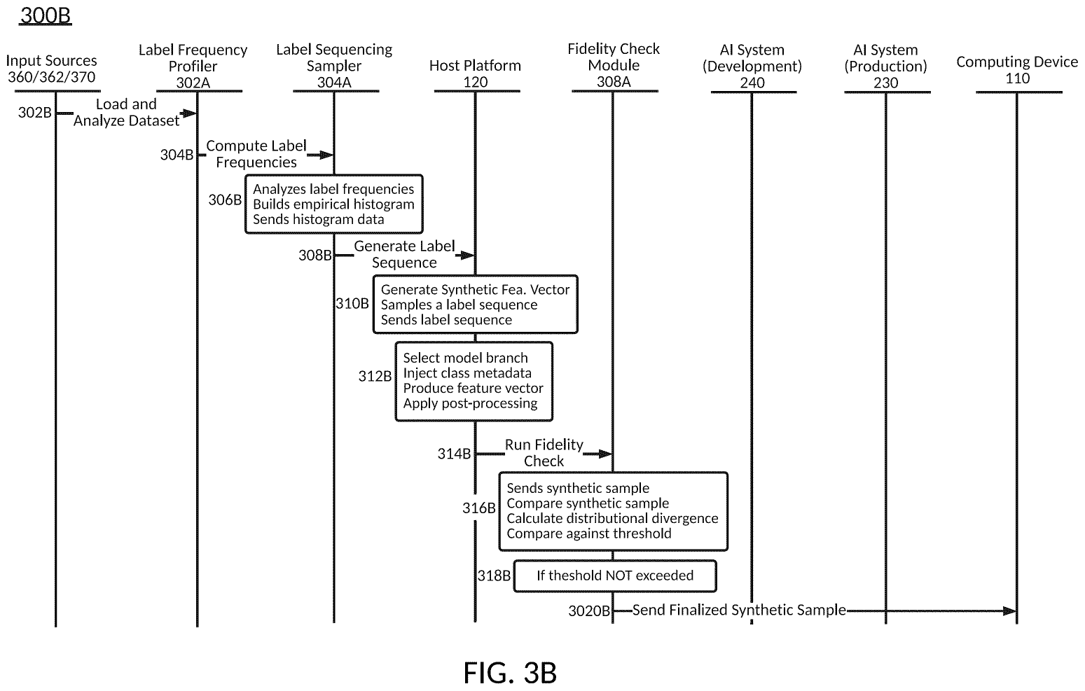

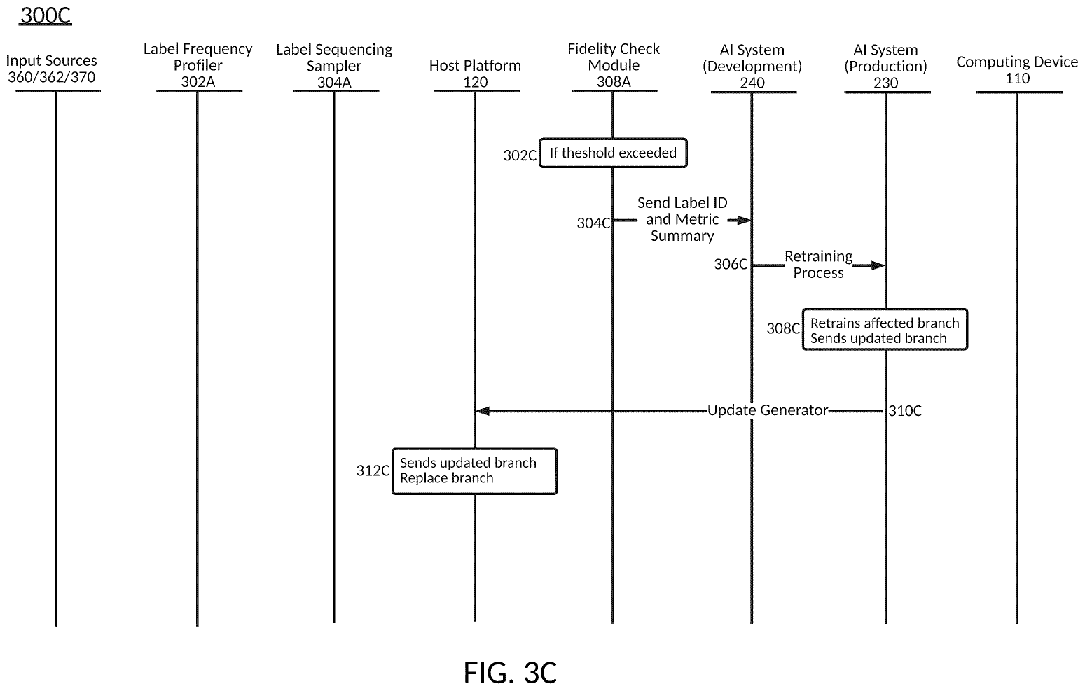

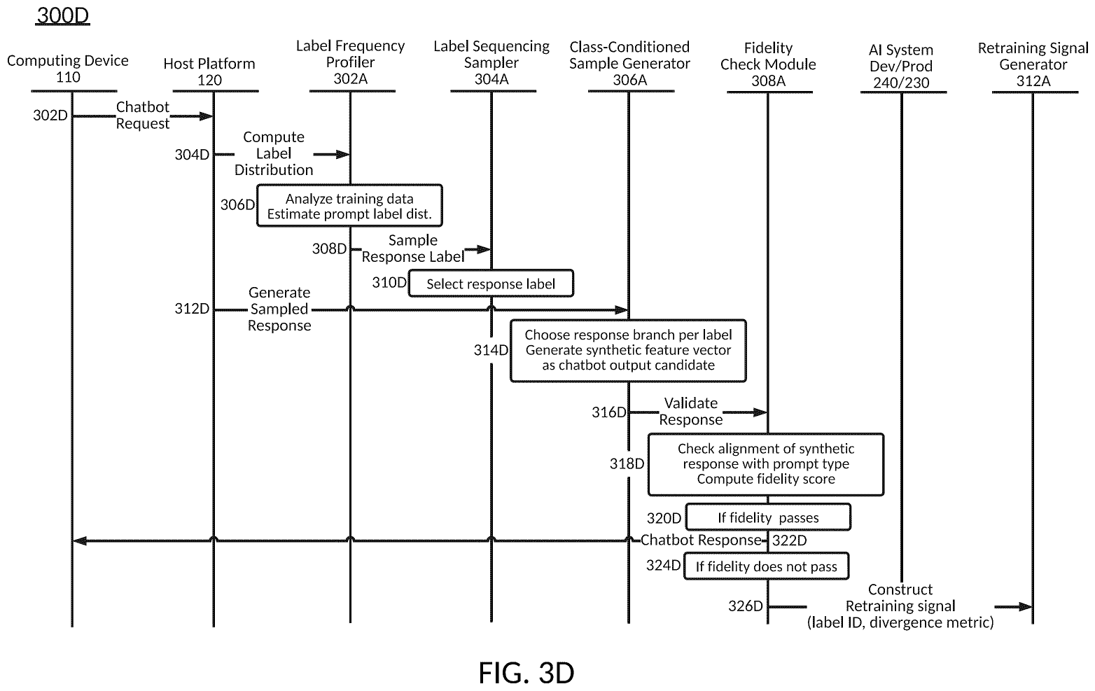

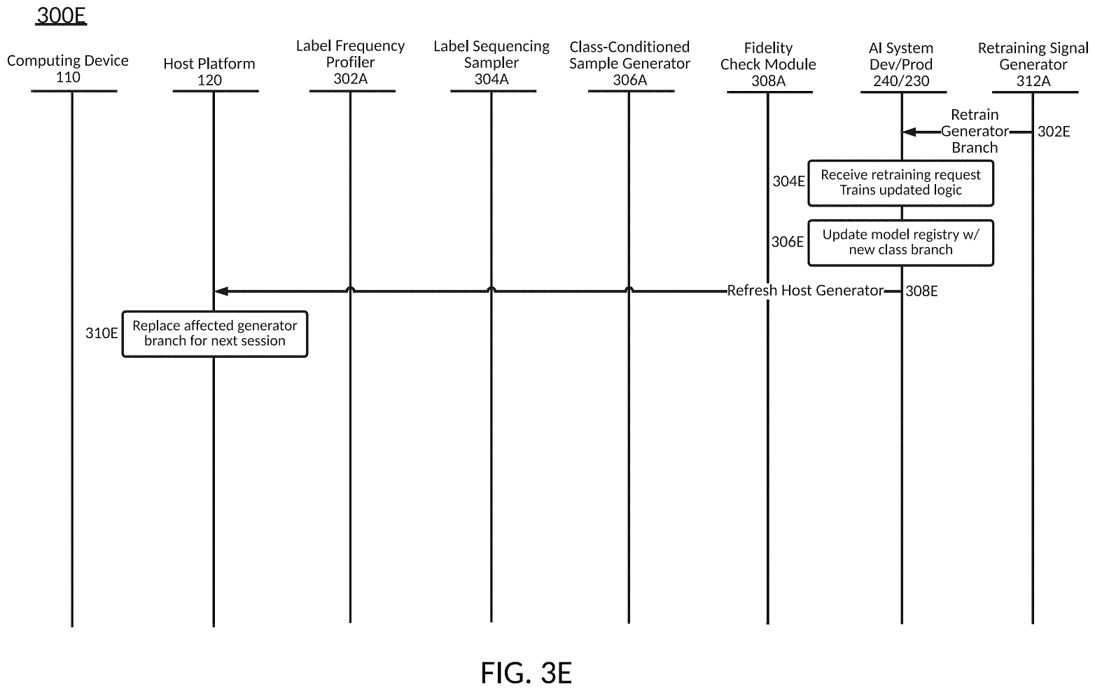

FIG. 3A is a system diagram illustrating an operating environment 300A for a class-balanced synthetic data generation and validation service that generates synthetic feature sets based on label distributions present in input data and enables retraining of the generative system when fidelity criteria are not met. The system is designed to address the limitations of conventional probabilistic sampling techniques by introducing label-aware sequencing and fidelity enforcement for high-quality, realistic synthetic outputs.

A computing device 110 is used to initiate and interact with the synthetic generation pipeline. The computing device 110 includes a software app 310, which may host user controls for initiating generation requests and visualizing synthetic results. The app may include a dashboard 312 that provides controls to select generation parameters, define evaluation tolerances, view sample quality metrics, and track retraining events.

The host platform 120 performs the core processing logic of the synthetic data generation workflow. The host platform 120 receives input from multiple data sources and routes that data through analytical, generative, and validation components. It is responsible for transforming label statistics into meaningful sampling behavior and ensuring fidelity between generated data and its real-world source distribution.

Input data includes prompt data 360, response data 362, and testing data 370, which represent pre-existing, labeled, or structured datasets collected from prior system behavior or domain-specific applications. These datasets serve as empirical ground truth used for label distribution profiling and fidelity evaluation. The datasets may include tabular features, natural language entries, numerical inputs, and corresponding class labels. All input sources are processed through the label frequency profiler 302A.

The label frequency profiler 302A analyzes the distribution of class labels across the provided datasets. This module computes the empirical frequency of each class and forms a histogram of label occurrences. Unlike conventional models that rely on multinomial or uniform random label sampling, the profiler ensures that minority and majority class proportions are preserved, mitigating imbalance risks during downstream generation.

The profiler outputs a normalized label distribution, which is passed to the label sequencing sampler 304A. The label sequencing sampler 304A generates a list of label values that represents a realistic sequence of target classes for conditional generation. The sampler may implement histogram-based sampling, label balancing heuristics, or class-prior weighting. Each label in the sequence serves as a conditioning factor for the generative model, enabling the creation of samples that reflect the diversity and representation of the training set.

The sampled label sequence is routed into the class-conditioned sample generator 306A, which generates synthetic feature sets based on the label sequence and associated conditioning metadata. The sample generator uses a model branch corresponding to each class label to generate feature vectors. The generator may internally include model variants trained per class or encode class information as part of the input vector. For each target label, the generator creates one or more synthetic samples that align with the expected feature space.

Generated samples are passed to the fidelity check module 308A, which evaluates whether the synthetic feature set satisfies minimum similarity thresholds with respect to the original dataset. This module performs distributional comparisons between the synthetic sample and the real data along dimensions such as feature variance, statistical correlation, label alignment, or structure similarity. Fidelity checks may include techniques such as KL divergence, mean squared error against feature embeddings, or rule-based pattern validation.

When a generated sample passes the fidelity check, it is finalized and forwarded to the computing device 110 as part of the synthetic output 310A. The synthetic output includes metadata such as the label used, fidelity score, generation timestamp, and internal feature trace. This output can be displayed on the dashboard 312 or exported for use in training or testing third-party models.

When a sample fails the fidelity check, a retraining signal generator 312A constructs a retraining signal. The signal includes the class label that failed, the observed divergence metric, and optionally the transformation configuration that led to the failure. The retraining signal is routed to the AI development system 240, which integrates it into the model refinement loop.

The AI development system 240 receives retraining signals and accesses historical training data, including historical prompt data 350 and historical response data 352. The system retrains or fine-tunes the class-conditioned generator using updated label distributions or error-specific training samples. The retraining process may selectively update underperforming class branches or alter label sequencing logic to increase output fidelity. The updated model is published to the AI model registry 260, where it is versioned and stored for retrieval.

The AI production system 230 consumes the updated model from the registry and hosts it in the form of a class-conditioned generator 332, which serves as the live generator model for subsequent synthetic generation requests. As the class-conditioned generator 332 continues to serve samples, evaluation data and performance metrics are accumulated in feedback data 334, which may be sent back to the development system 240 for additional retraining cycles.

The closed feedback loop enabled by modules 308A, 312A, 240, and 230 allows the system to continuously self-correct. Each generated sample is subject to validation, and failed outputs initiate targeted retraining of model components.

FIG. 3B illustrates a process flow 300B representing the runtime sequence of generating and validating synthetic feature vectors within a class-conditioned generative system. This flow details interactions between components including input sources, label processing logic, generation modules, and fidelity validation mechanisms that support the closed-loop operation of the instant solution.

The process begins with input sources, including prompt data 360, response data 362, and testing data 370. These sources contain labeled records collected during historical or live interactions and serve as the statistical basis for model-guided generation. These datasets are provided to a label frequency profiler 302A.

At step 302B, the label frequency profiler 302A loads and analyzes the input datasets. The profiler scans the training corpus and isolates class label occurrences to establish an accurate view of label prevalence. At step 304B, the label frequency profiler computes label frequencies and constructs a normalized label histogram that captures empirical class balance.

The label histogram is sent to a label sequencing sampler 304A. At step 306B, the label sequencing sampler interprets the histogram data to generate a list of labels that reflects the real-world distribution observed in the input. Unlike probabilistic random sampling, the label sequencing sampler enforces proportional representation of all classes, including low-frequency ones. This ensures downstream generation adheres to observed label statistics.

At step 308B, the label sequencing sampler 304A sends the generated label sequence to the host platform 120. The host platform 120 coordinates the generation of synthetic feature vectors for each label. At step 310B, the host platform samples from the label sequence and invokes synthetic feature vector generation, associating each label with a corresponding generation request.

The generation request is routed to the class-conditioned sample generator. At step 312B, the generator selects a model branch associated with the sampled label, injects class metadata, and uses the conditioned input to produce a synthetic feature vector. Post-processing may include normalization, embedding alignment, or data type formatting to match the expected output format.

At step 314B, the generated sample is submitted to the fidelity check module 308A. The fidelity check module performs automated validation of the synthetic sample to ensure quality and integrity. At step 316B, the module sends the synthetic feature vector to a comparison engine, evaluates alignment with known statistical features, calculates a distributional divergence metric, and compares the result against a predefined fidelity threshold.

When the fidelity threshold is not exceeded, meaning the synthetic output satisfies similarity thresholds, the module proceeds to step 318B. The synthetic sample is approved and marked as final. At step 3020B, the finalized synthetic sample is transmitted to the computing device 110 or stored for downstream processing or training. This fidelity gate ensures that synthetic samples that statistically and structurally resemble the original data are preserved.

FIG. 3C is a continuation 300C of the process flow illustrated in FIG. 3B. While FIG. 3B concludes with a synthetic sample passing fidelity checks and being finalized, FIG. 3C illustrates the complementary flow where the synthetic sample fails the fidelity validation. This initiates a targeted retraining loop that updates a specific generation branch within the class-conditioned model of the instant solution.

The process continues after the fidelity check module 308A has evaluated a synthetic feature vector and determined that its distributional divergence from the real data exceeds the acceptable fidelity threshold. At step 302C, the fidelity check module 308A records that the threshold was exceeded, indicating that the generated sample is not sufficiently representative of the corresponding label class.

At step 304C, the fidelity check module 308A generates a structured retraining signal that includes the affected label identifier and a summary of the divergence metric that caused the failure. This information is transmitted to the AI development system 240, which orchestrates retraining operations.

Upon receipt of the signal, the AI development system 240 initiates the retraining process at step 306C. The system identifies the relevant generator branch associated with the failing label and compiles a training set tailored to increase its fidelity. This may include labeled samples from prompt data 360, response data 362, testing data 370, and internal datasets such as historical prompt data 350 or historical response data 352. The retraining focuses exclusively on the affected portion of the model, preserving performance in unrelated branches.

At step 308C, the model retraining process is executed. The AI development system 240 updates the internal representation and generation parameters of the targeted model branch. Once retraining is complete, the updated branch is transferred to the AI production system 230, which integrates the modified model component into its serving environment.

At step 310C, the AI production system 230 registers the new model branch and initiates a generator update sequence. It confirms compatibility with existing deployment logic and prepares the updated component for real-time inference. The update is then communicated to the host platform 120.

At step 312C, the host platform 120 receives the updated branch and replaces the prior version in the active model environment. This update occurs without interrupting other label-specific branches, allowing the system to continue generating synthetic outputs while seamlessly integrating the updates.

The retraining process shown in FIG. 3C completes the fidelity-guided feedback loop that begins in FIG. 3B. Together, the two flows define a closed-loop architecture in which the synthetic data generator dynamically evolves in response to quantitative fidelity signals. This allows the instant solution to continuously refine its output quality and maintain close alignment with the statistical properties of the real-world training data.

In reference to FIGS. 3B and 3C, a method is provided for generating and calibrating synthetic data using a generative model conditioned on a target label schedule derived from an input dataset. The method begins with receiving a training dataset, which includes multiple samples, each sample characterized by one or more features and a corresponding class label. This data is supplied by a data source and ingested by the host platform 120, where it is processed for further computational operations.

Using the empirical label distribution, the processor samples a label sequence to define a target label schedule for data synthesis. A label sequencing sampler draws class labels from a multinomial distribution parameterized by the empirical distribution, ensuring that each class is represented proportionally, and optionally applying stratification logic to maintain balanced representation across all classes.

A class-conditioned sample generator receives the sampled label sequence and, for each label, generates a synthetic feature vector. The generator is a machine learning model, such as a gradient-boosted decision tree ensemble or neural network, with distinct branches or pathways corresponding to each class. The generator may be enhanced with class-aware noise vectors, perturbation vectors scaled using per-class feature statistics derived from the original training dataset, applied to the input layer to enhance diversity while preserving label fidelity.

As synthetic feature vectors are produced, they are evaluated by a comparison module, which performs class-wise distribution comparisons. Specifically, the divergence between the distribution of generated vectors for each class and the subset of the original dataset belonging to that class is computed. Divergence may be assessed using metrics such as Kullback-Leibler divergence or Earth Mover's Distance. The result of this comparison is a fidelity score for each class.

The generative model is then calibrated based on these fidelity scores. Calibration logic adjusts the parameters of the model for classes where the measured divergence exceeds a predefined threshold. The system thus avoids overfitting and ensures model refinement focuses on underperforming regions of the class-conditioned space. The calibration step may involve fine-tuning the model independently for each class branch using subsets of generated data corresponding to that class, enabling targeted performance enhancements.

Before data generation, the training dataset is preprocessed through a normalization engine that applies class-specific normalization schemes. These schemes ensure feature values are scaled uniformly within each class, thereby aligning the feature ranges and increasing generative quality.

To accelerate sampling throughput, the empirical label probabilities are optionally cached in a fixed-size lookup table, enabling rapid access during generation cycles.

FIG. 3D is a process diagram 300D that illustrates a chatbot-specific operational sequence for generating and validating a response using a class-conditioned generative pipeline. This flow extends the earlier logic of label-based synthetic generation (as shown in FIG. 3B) but contextualizes it for real-time chatbot applications. The process includes prompt classification, conditional response generation, fidelity evaluation, and conditional retraining.

At step 302D, a computing device 110 issues a chatbot request to the host platform 120, which initiates the generation pipeline. The chatbot request may originate from a software client or API running on the device, such as a mobile application or browser-based chatbot UI.

At step 304D, the host platform 120 triggers a label profiling sequence to analyze the nature of the chatbot prompt. The label frequency profiler 302A receives the prompt data and computes an updated label distribution. This label distribution reflects the statistical frequencies of response categories (e.g., informative, humorous, directive) based on historical training data. The host platform generates 312D the sampled response that is sent to the class-conditioned sample generator 306A.

At step 306D, the label frequency profiler 302A analyzes training data to estimate prompt label distributions and passes the result to the label sequencing sampler 304A. This module selects a response label at step 308D and sends it downstream for conditional generation. At step 310D, the label sequencing sampler finalizes the label selection, which guides response generation by determining the proper conditional branch.

At step 314D, the class-conditioned sample generator 306A receives the response label and chooses the corresponding generation branch. The module uses this branch to synthesize a feature vector that represents a candidate chatbot output. Class metadata is injected to condition the output, and post-processing is performed when applicable (e.g., text decoding, formatting).

At step 316D, the synthetic response is routed to the fidelity check module 308A, which initiates a validation phase. This component of the instant solution's self-verification design ensures that chatbot responses are consistent with the label and context from which they were generated.

At step 318D, the fidelity check module 308A compares the generated response against expectations. It evaluates how well the synthetic response aligns with the original prompt, class type, and training distribution. A fidelity score is computed based on structural, semantic, or statistical similarity metrics.

The result of the fidelity check is processed conditionally. When the response passes (step 320D), it is sent back to the host platform 120 as a chatbot response at step 322D. The host platform then relays the validated response back to the computing device 110 for display or interaction.

When the response fails the fidelity threshold (step 324D), a retraining trigger is issued. At step 326D, the fidelity check module 308A sends label-specific metadata to the retraining signal generator 312A. This includes the failed label ID and the computed divergence metric. The retraining signal generator 312A then constructs a feedback packet that will be routed to the AI development system 240 and AI production system 230 as input for targeted model refinement, as described in FIG. 3C. The sequence in FIG. 3D represents a real-time instantiation of the instant solution's generative and fidelity validation architecture, applied in the context of chatbot interaction.

FIG. 3E is a continuation 300E of the chatbot response flow illustrated in FIG. 3D. While FIG. 3D concludes with a fidelity evaluation and, when necessary, the construction of a retraining signal, FIG. 3E depicts the downstream lifecycle of that retraining request, including generator branch updates, registry refresh, and integration of updated logic into the host platform 120 for future chatbot sessions.

The sequence continues at step 302E, where the retraining signal generator 312A issues a retrain command targeted to the affected generator branch. This command is sent to the AI development system 240 and AI production system 230, which manages model training, evaluation, and deployment pipelines.

At step 304E, the AI system receives the retraining request and initiates a selective training process to update the logic of the specific class-conditional branch that failed fidelity in the previous session. The retraining data may include prompt data 360, response data 362, and failure-specific metrics, as well as feature alignment scores and divergence values recorded by the fidelity check module 308A.

Upon successful retraining, the system proceeds to step 306E, where the updated generator branch is published to the AI model registry 260. This ensures that the latest version of the generator is tracked, versioned, and available for immediate distribution to serving infrastructure. The registry maintains branch-level metadata, enabling targeted retrieval and update operations for specific class paths within a multi-branch generative model.

At step 308E, the fidelity check module 308A or deployment orchestrator triggers a refresh of the host platform 120 to incorporate the newly updated class branch. The refresh does not request redeployment of the entire model, ensuring lightweight, real-time adaptability of the generative system.

Finally, at step 310E, the host platform 120 replaces the previously failing branch with the updated version. This update is staged for the next chatbot session involving the same class type. When the computing device 110 issues a new prompt that maps to the affected label, the updated branch will be used to generate a more accurate and fidelity-compliant synthetic response.

FIG. 3E completes the closed-loop retraining cycle initiated in FIG. 3D. Together, these flows demonstrate the self-healing capabilities of the instant solution. When a fidelity violation is detected, the system localizes the issue, retrains the relevant logic, and replaces the relevant generator path, all with minimal latency and without manual intervention.

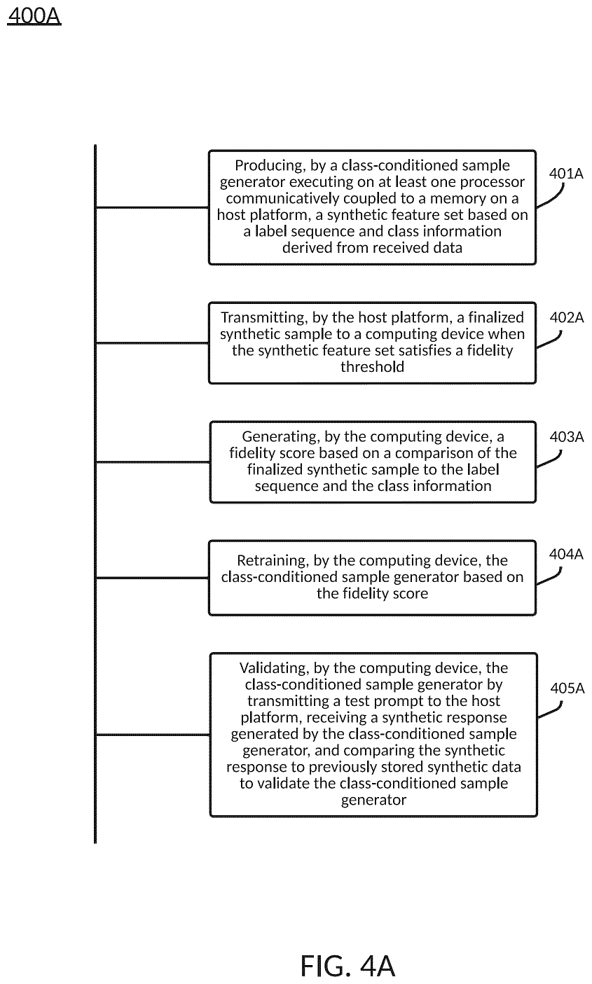

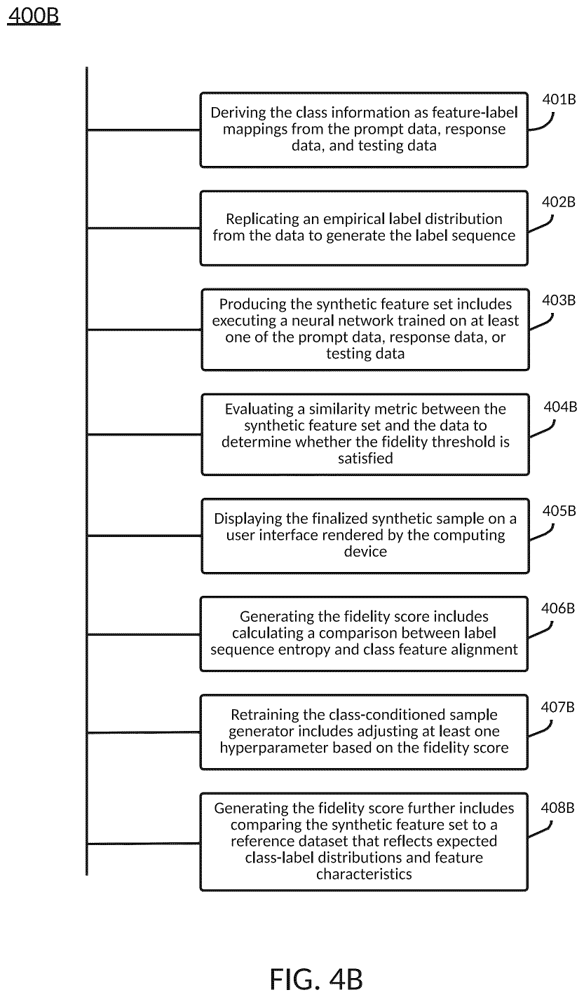

FIG. 4A illustrates an example of a method 400A for generating class-balanced synthetic data with fidelity-guided retraining according to examples and features of the instant solution. As an example, the method 400A may be performed by a computing system, a software application, a server, a cloud platform, a combination of systems, and the like. Referring to FIG. 4A, in 401A, the method may include producing, by a class-conditioned sample generator executing on at least one processor communicatively coupled to a memory on a host platform, a synthetic feature set based on a label sequence and class information derived from received data. In 402A, the method may include transmitting, by the host platform, a finalized synthetic sample to a computing device when the synthetic feature set satisfies a fidelity threshold. In 403A, the method may include generating, by the computing device, a fidelity score based on a comparison of the finalized synthetic sample to the label sequence and the class information. In 404A, the method may include retraining, by the computing device, the class-conditioned sample generator based on the fidelity score. In 405A, the method may include validating, by the computing device, the class-conditioned sample generator by transmitting a test prompt to the host platform, receiving a synthetic response generated by the class-conditioned sample generator, and comparing the synthetic response to previously stored synthetic data to validate the class-conditioned sample generator.

FIG. 4B illustrates a method 400B for generating class-balanced synthetic data with fidelity-guided retraining according to other examples and features of the instant solution. As an example, the method 400B may be performed by a computing system, a software application, a server, a cloud platform, a combination of systems, and the like. Referring to FIG. 4B, in 401B, the method may include deriving the class information as feature-label mappings from the prompt data, response data, and testing data. In 402B, the method may include replicating an empirical label distribution from the data to generate the label sequence. In 403B, the method may include producing the synthetic feature set includes executing a neural network trained on at least one of the prompt data, response data, or testing data. In 404B, the method may include evaluating a similarity metric between the synthetic feature set and the data to determine whether the fidelity threshold is satisfied. In 405B, the method may include displaying the finalized synthetic sample on a user interface rendered by the computing device. In 406B, the method may include generating the fidelity score includes calculating a comparison between label sequence entropy and class feature alignment. In 407B, the method may include retraining the class-conditioned sample generator includes adjusting at least one hyperparameter based on the fidelity score. In 408B, the method may include generating the fidelity score further includes comparing the synthetic feature set to a reference dataset that reflects expected class-label distributions and feature characteristics.

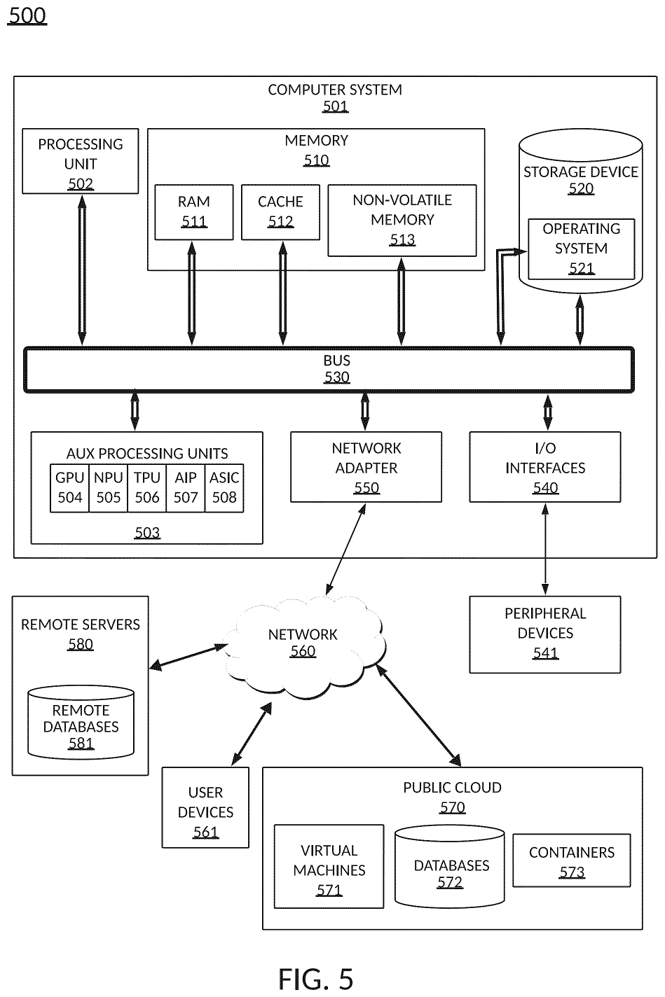

The examples and features of the instant solution may be implemented in at least one of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain at least one Graphics Processing Unit (GPU) 504, Neural Processing Unit (NPU) 505, Tensor Processing Unit (TPU) 506, AI Processor (AIP) 507, or other Application Specific Integrated Circuit (ASIC) 508. The at least one APU 503 may contain circuitry distributed over multiple integrated circuit chips. Each APU 503 may implement multiple processor threads and multiple processor cores. Each APU 503 may include at least one of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, at least one of the at least one APU 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520 and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing device. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

In connection with FIG. 3A, the components of FIG. 5 can be used to implement and support the host platform 120, computing device 110, AI development system 240, and AI production system 230 of the instant solution. For example, the host platform 120 may be instantiated on the computer system 501 using processing unit 502 and auxiliary processing units 503 (e.g., GPU 504, TPU 506, or AI processor 507) to execute the class-conditioned sample generator 306A, fidelity check module 308A, and retraining signal generator 312A. The RAM 511 and non-volatile memory 513 may temporarily and persistently store components of the label frequency profiler 302A and label sequencing sampler 304A, including intermediate label histograms and class sequences.

The computing device 110, shown in FIG. 3A as running software app 310 and dashboard 312, may correspond to a user device 561 or a client process deployed in a public cloud 570 via a container 573 or virtual machine 571. These user-facing components may interface with the host platform 120 through the network 560 and network adapter 550 of computer system 501 to transmit prompt data and display generated synthetic outputs.

The AI development system 240 and AI production system 230 may each be implemented across cloud-based infrastructure or remote servers 580. For instance, training of generator branches using feedback and synthetic divergence metrics may be performed in a distributed compute cluster provisioned through virtual machines 571 or with support from dedicated hardware like AI processors 507. Retrained model branches are stored in an AI model registry, which may reside within databases 572 of the public cloud 570 or remote databases 581, and retrieved using secure access protocols via network 560.

The fidelity check module 308A may utilize data from the input sources (prompt data 360, response data 362, testing data 370), all of which may be housed within storage device 520, remote databases 581, or streaming from network-connected data pipelines. Upon detecting fidelity failure, divergence thresholds, and associated class identifiers are encoded and routed through retraining signal generator 312A to initiate targeted retraining requests managed by AI development system 240.

This computing environment enables the real-time, closed-loop synthetic data generation and validation architecture described throughout this instant solution. Each layer of functionality, from label profiling and synthetic generation to fidelity enforcement and model retraining, is mapped onto scalable and interoperable computing resources, including local and distributed compute, network, and data storage elements, as shown in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

The instant solution provides a concrete and operationally valuable mechanism for enhancing language-model-based inference by dynamically filtering and selecting auxiliary prompts that are most relevant to a given target prompt. In real-world scenarios, AI performance is often constrained by irrelevant or misaligned context. The disclosed architecture addresses this by encoding a set of annotated prompts and the incoming target prompt into latent vector form using a shared transformer encoder. These latent representations are used to calculate similarity scores and build a graph that identifies clusters of semantically related prompts. To further refine selection, a prompt divergence classifier is applied to score the similarity of each auxiliary prompt to the target prompt. The top-ranked auxiliary prompts, such as those with the highest combined similarity and lowest divergence, are retained. These selected prompts are then used to condition the inference process, ensuring that the generated response is guided by the most relevant and distribution-aligned information. This results in improved inference quality, reduced hallucination risk, and more predictable system behavior. Practical deployments include real-time conversational agents, adaptive prompt routers for vertical LLMs, and edge devices with constrained context capacity. By optimizing the set of active prompts for each inference session, the system supports faster, more reliable, and contextually aligned AI outputs in production environments.

In deployment, a user interacts with the system via a configuration interface or programmatic API. Initially, the user uploads a collection of labeled prompts that form the annotated source prompt set. These prompts may represent prior use cases, canonical queries, or training-aligned examples. A target prompt, typically received from a real-time application or test suite, is also entered into the system.

Upon execution, the system encodes all prompts into latent vectors using a shared transformer encoder. Through the user interface, the user can view a visual representation of prompt clustering and similarity relationships. Adjustable parameters, such as graph similarity thresholds or divergence scoring weights, allow the operator to tune how strictly auxiliary prompts must align with the target. Once the similarity graph is built and divergence scores are calculated, the system presents a ranked list of auxiliary prompts selected to support the target prompt. The operator can inspect these selections, view scoring justifications, and override inclusion or exclusion based on domain knowledge or specific testing goals.

After the auxiliary prompt set is finalized, the operator can initiate an inference session using the filtered set or export the configuration for batch or production deployment. Throughout this process, the interface logs interaction results, capturing inference quality metrics and prompt selection performance. The operator may use this feedback to retrain the divergence classifier, adjust scoring thresholds, or iterate on the prompt dataset.

What is claimed is:

1. An apparatus, comprising:
a computing device; and
a host platform comprising:
a memory; and
at least one processor communicatively coupled to the memory, the at least one processor configured to:
produce, using a class-conditioned sample generator, a synthetic feature set based on a label sequence and class information based on received data; and
transmit, when the synthetic feature set satisfies a fidelity threshold, a finalized synthetic sample to the computing device;
wherein the computing device is configured to:
generate a fidelity score based on a comparison of the finalized synthetic sample to the label sequence and the class information;
use the fidelity score to retrain the class-conditioned sample generator; and
validate the class-conditioned sample generator by transmitting a test prompt to the host platform, receiving a synthetic response generated by the class-conditioned sample generator, and comparing the synthetic response to previously stored synthetic data to validate the class-conditioned sample generator.

2. The apparatus of claim 1, wherein the class information comprises feature-label mappings derived from the received data which includes prompt data, response data, and testing data.

3. The apparatus of claim 1, wherein the at least one processor is configured to generate the label sequence based on label frequencies corresponding to received data from a data source using a label sequencing sampler, wherein the label sequencing sampler is configured to replicate empirical label distribution derived from the received data.

4. The apparatus of claim 1, wherein the class-conditioned sample generator comprises a neural network trained on at least one of prompt data, response data, or testing data.

5. The apparatus of claim 1, wherein the fidelity threshold is based on similarity metrics between the synthetic feature set and the received data.

6. The apparatus of claim 1, wherein the computing device comprises a display configured to render the finalized synthetic sample to a user interface.

7. The apparatus of claim 1, wherein the fidelity score is calculated using a comparison of label sequence entropy and class feature alignment.

8. The apparatus of claim 1, wherein retraining the class-conditioned sample generator includes selecting updated hyperparameters based on the fidelity score.

9. The apparatus of claim 1, wherein the fidelity score is further based on a comparison between the synthetic feature set and a reference dataset that reflects expected class-label distributions and feature characteristics.

10. The apparatus of claim 1, wherein comparing the synthetic response to previously stored synthetic data includes computing a differential accuracy metric.

11. A method, comprising:
producing, by a class-conditioned sample generator executing on at least one processor communicatively coupled to a memory on a host platform, a synthetic feature set based on a label sequence and class information derived from received data;
transmitting, by the host platform, a finalized synthetic sample to a computing device when the synthetic feature set satisfies a fidelity threshold;
generating, by the computing device, a fidelity score based on a comparison of the finalized synthetic sample to the label sequence and the class information;
retraining, by the computing device, the class-conditioned sample generator based on the fidelity score; and
validating, by the computing device, the class-conditioned sample generator by transmitting a test prompt to the host platform, receiving a synthetic response generated by the class-conditioned sample generator, and comparing the synthetic response to previously stored synthetic data to validate the class-conditioned sample generator.

12. The method of claim 11, further comprising deriving the class information as feature-label mappings from prompt data, response data, and testing data.

13. The method of claim 11, further comprising generating the label sequence based on label frequencies corresponding to received data from a data source using a label sequencing sampler, wherein the label sequencing sampler is configured to replicate empirical label distribution derived from the received data.

14. The method of claim 11, wherein producing the synthetic feature set includes executing a neural network trained on at least one of prompt data, response data, or testing data.

15. The method of claim 11, further comprising evaluating a similarity metric between the synthetic feature set and the received data to determine whether the fidelity threshold is satisfied.

16. The method of claim 11, further comprising displaying the finalized synthetic sample on a user interface rendered by the computing device.

17. The method of claim 11, wherein generating the fidelity score includes calculating a comparison between label sequence entropy and class feature alignment.

18. The method of claim 11, wherein retraining the class-conditioned sample generator includes adjusting at least one hyperparameter based on the fidelity score.

19. The method of claim 11, wherein generating the fidelity score further includes comparing the synthetic feature set to a reference dataset that reflects expected class-label distributions and feature characteristics.

20. A computer program product comprising:
at least one computer-readable storage medium; and
program instructions stored on the at least one computer-readable storage medium to perform operations comprising:
producing, by a class-conditioned sample generator executing on at least one processor communicatively coupled to a memory on a host platform, a synthetic feature set based on a label sequence and class information derived from received data;
transmitting, by the host platform, a finalized synthetic sample to a computing device when the synthetic feature set satisfies a fidelity threshold;
generating, by the computing device, a fidelity score based on a comparison of the finalized synthetic sample to the label sequence and the class information;
retraining, by the computing device, the class-conditioned sample generator based on the fidelity score; and
validating, by the computing device, the class-conditioned sample generator by transmitting a test prompt to the host platform, receiving a synthetic response generated by the class-conditioned sample generator, and comparing the synthetic response to previously stored synthetic data to validate the class-conditioned sample generator.
